(19) United States
(12) Patent Application Publication
(10) Pub. No.: US 2011/0048007 A1
(43) Pub. Date: Mar. 3, 2011

(54) POWER CONVERSION APPARATUS

(75) Inventor: Gary Murphy, Parklands Widnes (GB)

(73) Assignee: HEPTRON LIMITED, Kirkby, Liverpool (GB)

(21) Appl. No.: 12/810,440

(22) PCT Filed: Dec. 23, 2008
(86) PCT No.: PCT/GB08/04282

§ 371 Date: Sep. 28, 2010

(30) Foreign Application Priority Data
Dec. 24, 2007 (GB) 0725200.0

(51) Int. Cl. F03G 7/00

(52) U.S. Cl. 60/641.6

(57) ABSTRACT

The present application relates to a power conversion device suitable for converting a temperature differential between two fluids into a source of energy comprising: a pressure vessel comprising at least one inlet hatch, suitable for receiving a first fluid of a first temperature and at least one outlet hatch suitable for venting said first fluid; and a fluid dispersal means for dispersing a second fluid of a second temperature greater than the temperature of the first fluid; and further comprising at least one master piston moveable with respect to at least one master cylinder between a first and second position, said master piston and master cylinder in fluid communication with the pressure vessel such that the fluid dispersal means causes the second fluid to increase the temperature and volume of the first fluid resulting in movement of the master piston within the master cylinder.

The present invention relates to an energy conversion device, particularly, an energy conversion device employing a temperature differential of a fluid as the source of energy.

There are currently many ways of generating electrical power, such as using wind and hydroenergy, fossil fuels, bio-fuels, fuel cells and atomic energy. In today's society, consumers are demanding far more power as new markets for consumer electrical goods expand. Often a nation's power suppliers have difficulty in meeting the demand for electricity required by customers.

An inherent problem with fossil fuel power plants is that the supply of fossil fuels is limited and the plants often produce unwanted “greenhouse” gases such as carbon dioxide as waste products, that is gases that are believed to be detrimental to the environment.

Atomic energy is regarded as an efficient way of producing electricity. However, atomic energy plants also have associated hazard and waste disposal problems.

Renewable energy power plants, while non-polluting and relatively safe, are limited for further exploitation by a lack of suitable new sites. For example, a reservoir is generally required for generating hydroelectricity, a requirement which is often difficult and costly to meet. A further problem with fossil fuel and atomic energy power plants is that they tend to generate a substantial amount of waste heat and water. If such waste heat and water could be utilized to generate more electricity it would be beneficial to consumers and the environment and also the supplier of the power.

It is therefore an object of the present invention to provide a power conversion device that aims to alleviate the abovementioned drawbacks, and in particular provide a device for generating power that is both efficient and environmentally friendly.

According to a first aspect of the present invention there is provided a power conversion device suitable for converting a temperature differential between two fluids into a source of energy comprising:
a pressure vessel comprising at least one inlet hatch, suitable for receiving a first fluid of a first temperature and at least one outlet hatch suitable for venting said first fluid; and
a fluid dispersal means for dispersing a second fluid of a second temperature greater than the temperature of the first fluid; and
further comprising at least one master piston moveable with respect to at least one master cylinder between a first and second position, said master piston and master cylinder in fluid communication with the pressure vessel such that the fluid dispersal means causes the second fluid to increase the temperature and volume of the first fluid resulting in movement of the master piston within the master cylinder.

In one embodiment of the present invention the master piston is preferably provided with at least one return piston and cylinder to effect movement thereof. The return piston (also known as the pneumatic return piston) may be located within the master piston or may be positioned adjacent thereto.

The power conversion device preferably further comprises an automatic control means to effect opening and closing of the inlet and outlet hatches and/or activation of the fluid dispersal means.

The automatic control means preferably comprises at least one valve, cylinder and piston arrangement, for controlling the entry and exit of fluid to and from the pressure vessel.

A valve, cylinder and piston arrangement is preferably located at the inlet and outlet hatches of the pressure vessel.

Also in connection with the power conversion device of the present invention the device preferably further comprises a first reservoir, suitable for supplying the first fluid to the pressure vessel. The device further comprises a return cylinder and a return piston in fluid communication with the master cylinder and master piston.

The at least one reservoir containing a fluid, such as air, is preferably in fluid communication with the return cylinder and/or slave cylinder. A compressor is preferably connected to the reservoir for affecting compression of a fluid within the reservoir. More preferably, a valve means is provided for controlling the flow of fluid to or from the reservoir and to or from the return cylinder and/or slave cylinder.

Likewise, at least one second valve for controlling the flow of fluid from the first reservoir to the return cylinder is also preferably provided.

There is also present a slave piston and slave cylinder in fluid communication with the master cylinder and master piston. Furthermore, a valve, preferably a non-return valve is in fluid communication with the slave piston and slave cylinder is also provided.

When the first fluid is air the reservoir is preferably filled by means of a compressor. Furthermore, the first reservoir is supplied with a sensor for detecting the pressure and/or volume of fluid therein and the sensor is connected to a central processing unit. Preferably the compressor is provided for initial filling up of the reservoir. Preferably the reservoir is fluidly connected to a pump or turbine to generate electricity via a valve. The excess compressed air may be utilised to operate a hydraulic or pneumatic motor. Preferably the reservoir includes a sensor to detect the capacity of said reservoir. Preferably at least one sensor is provided on the inside of the pressure vessel and at least one sensor is provided external to the pressure vessel, and said sensors are connected to the central processing unit.

Therefore, in one embodiment of the present invention, the apparatus is able to effect movement of the master piston in one direction only by means of the expanded fluid. In such an embodiment, injector means is provided for dispersing fluid of a second temperature, said dispersion preferably being carried out when the master piston is fully extended causing the volume of the pressure vessel to be at a minimum.

Also according to the present invention there is preferably a temperature differential of at least 10° C. between any temperature readings recorded by the sensors on the inside and outside of the pressure vessel respectively. However, there is preferably a maximum temperature differential of at least 139° C. between any temperature readings recorded by the sensors on the inside and outside of the pressure vessel respectively.

In the device of the present invention there is preferably at least one inlet hatch proximity switch and at least one outlet hatch proximity wherein, the inlet and outlet hatch proximity switches are located in the region of the inlet and outlet hatches respectively.

There is also preferably a second reservoir for supplying the second fluid to the pressure vessel.

The device of the present invention also preferably comprises a means for transferring the second fluid from the second reservoir to the pressure vessel. When the second fluid comprises water, the means for transferring the second fluid from the second reservoir to the pressure vessel comprises a water pump.

In the device of the present invention the pressure vessel preferably comprises a cavity wall for receiving the second fluid.

The device also preferably comprises a heat exchanger through which the second fluid passes after circulating through the pressure vessel and prior to entering the second reservoir.

It is preferred in the device of the present invention that the temperature of the second fluid in the second reservoir is in the range of 10° C. to 99° C., more preferably 20° C. to 99° C. and most preferably between 40° C. and 99° C. The second fluid preferably 120 comprises water.

The fluid dispersal means preferably comprises at least one injection nozzle. Alternatively, in the power conversion device of the present invention the fluid dispersal means comprises a number of injection nozzles, arranged in rows along the length of the pressure vessel.

There is also preferably provided an injection valve suitable for controlling the flow of the second fluid from the second reservoir to the one or more injection nozzles. It is preferable to provide automatic control means for activation of at least one injection valve.

Alternatively, the fluid dispersal means comprises at least one heat exchanger and a conduit connects fluid from the second reservoir to the at least one heat exchanger. In accordance with the present invention the first reservoir is connected to a means suitable for use in the generation of electricity. The means suitable for use in the generation of electricity comprises a turbine and/or one or more pumps.

Also in the present invention the power conversion device preferably further comprises at least one cam rod connected to the at least one master piston. The cam rod is preferably further connected to a crankshaft.

In this embodiment of the present invention the master piston is preferably provided with at the least one cam rod to effect movement thereto. The said cam rod may be located within the master piston or may be positioned adjacent thereto. The said cam rod may connect the master piston to a crankshaft.

It will be appreciated by one skilled in the art that a series of pressure vessels, master piston/cylinders and/or slave pistons/cylinders and/or actuating pistons/cylinders and/or cam rods may be provided along a crankshaft to increase the output of the apparatus.

The device therefore also preferably comprises a series of master cylinders and master pistons each connected to a cam rod respectively which is in turn connected to a single crankshaft.

In an alternative embodiment of the present invention the power conversion device preferably further comprises at least one electromagnetic inductive bar, said electromagnetic inductive bar housed within an inductive coil and wherein said electromagnetic inductive bar is connected to the at least one master piston. In the arrangement, movement of the master piston causes the electromagnetic inductive bar to move within the inductive coil thereby generating an electro-motive force.

In this alternative embodiment it is the master piston which is preferably provided with for example at least one magnetic bar within an electromagnetic coil to effect movement thereto. The magnetic bar may be located within the master piston or may be positioned adjacent thereto. The magnetic bar may also be used to induce an electro motive force into the electromagnetic coil.

The said electro-motive force may pass through electronic control circuitry that may change the form of the induced electro-motive force before delivering the induced electro motive force to external circuitry.

In use, all or part of the electro-motive force generated by movement of the electromagnetic inductive bar within the inductive coil by the device may be fed to the central processing unit.

In yet a further embodiment of the present invention the master piston/cylinder is preferably built on a vertical axis, in such an embodiment the master piston travels in an upward direction due to the expanding fluids and returns in a downward direction due to the forces of gravity acting upon the piston.

It is to be appreciated that a series of pressure vessels, master piston/cylinders and/or slave pistons/cylinders and/or actuating pistons/cylinders and/or cam rods may be provided along a crankshaft to increase the output of the apparatus.

In accordance with a second aspect of the present invention there is provided a method suitable for transferring a temperature differential of at least two fluids into motive power using a device as described in relation to the first aspect of the present invention comprising the steps of:
moving at least one master piston within at least one master cylinder;
introducing a first fluid of a first temperature into a pressure vessel, said pressure vessel in fluid communication with the at least one master piston;
introducing a second fluid of a second temperature into said pressure vessel so as to cause expansion of the first fluid in the pressure vessel and thereby cause movement of the at least one master piston within the master cylinder in a first direction.

In the method of the present invention the second fluid is introduced into the pressure vessel by means of one or more injection nozzles or one or more heat exchanger(s).

Also, movement of the master piston with the master cylinder causes movement of a slave piston within a slave cylinder that compresses the first fluid through a non-return valve into a first reservoir.

Furthermore, movement of the master piston with the master cylinder causes movement of a cam rod connected to a crankshaft.

Alternatively, movement of the master piston with the master cylinder causes movement of at least one electromagnetic inductive bar within an inductive coil, and movement of the electromagnetic inductive bar within the inductive coil generates an electro-motive force.

Also in the method of the present invention the introduction and exhaustion of fluids to and from the pressure vessel is preferably controlled by one of more valves. The operation of the valves is controlled by a central processing unit.

Furthermore, at least one sensor is preferably provided within the first reservoir that determines the level of first fluid in the reservoir and hence commencement of a cycle of the power conversion device.

The method of the present invention also preferably comprises the step of moving a return piston within a return cylinder to move the at least one master piston within the master cylinder in a second direction, and wherein movement of the master cylinder in the second direction coincides with opening of at least one inlet hatch, and at least one outlet hatch.

The method also preferably comprises the steps of closing the at least one inlet hatch, and at least one outlet hatch when fluid in the pressure vessel is of a pre-determined temperature.

The pre-determined temperature of the fluid inside the pressure vessel is preferably detected by a sensor which is connected to a central processing unit.

The method also further comprises the steps of introducing the second fluid of a second temperature into the pressure vessel when the inlet and outlet hatches are closed. The second fluid of a second temperature is introduced into the pressure vessel by means of one or more injection nozzle. Alternatively, the second fluid of a second temperature is introduced into the pressure vessel by means of at least one heat exchanger.

Also in the method of the present invention, introduction of the second fluid of a second temperature into the pressure vessel causes expansion of the first fluid of the first temperature to act on the master piston within the master cylinder followed by action of the master piston on a slave piston in a slave cylinder which in turn compresses the first fluid of the first temperature which is forced into the first reservoir via a non-return valve.

Therefore, in summary the principle behind the present invention is to convert the temperature differential of fluids into motive power. Fluid of a first temperature, such as cold air is drawn into the pressure vessel followed by the injection of fluid of a second temperature, such as warm water. The injection of warm water is transformed into a fine warm mist with a large surface area. The large surface area of the warm mist increases the rate of heat transfer to the cold air. As the heat energy warms up the cold air, the cold air expands and increases in volume thereby directly or indirectly driving a master piston in one direction. The volume of the master cylinder is smaller than that of the pressure vessel thereby amplifying the extent of travel of the master piston caused by expansion of the fluid in the pressure vessel.

This motion may be used to generate power such as electricity. The motion of the piston may be used, for example, to drive a series of further pistons to magnify the transfer of energy and/or to affect movement of cams to cause rotation of a crankshaft and/or to affect movement of a magnetic bar through a coil of wire thereby inducing an electro motive force (emf).

For a better understanding of the present invention and to show more clearly how it may 250 be carried into effect, the invention will now be described further with reference made by way of example only, to the accompanying drawings in which:

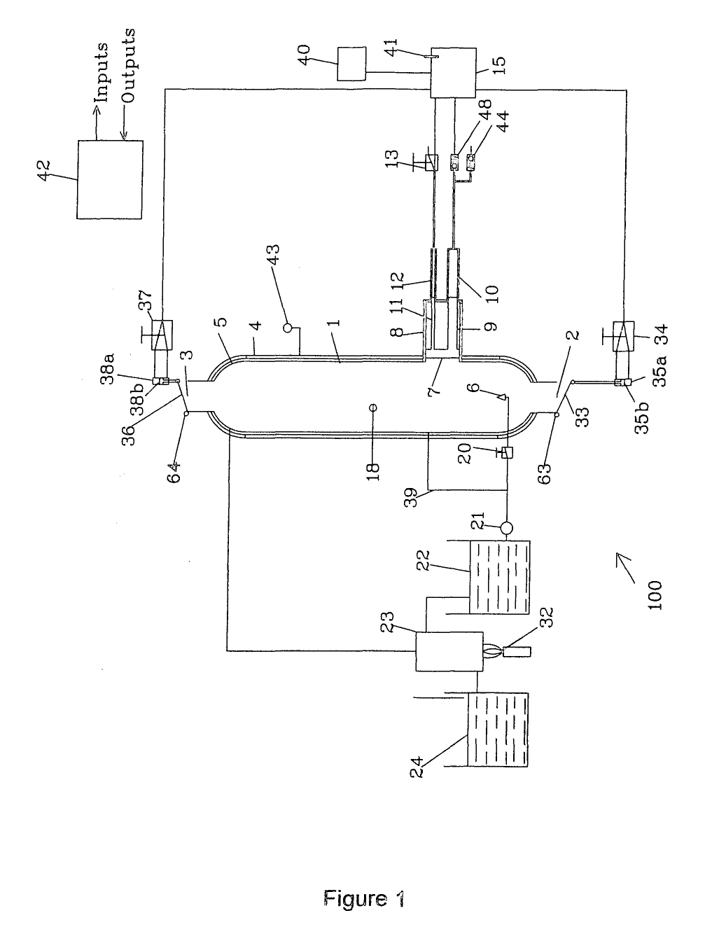

FIG. 1—illustrates an energy conversion apparatus according to the present invention with a master piston, master cylinder and valves.

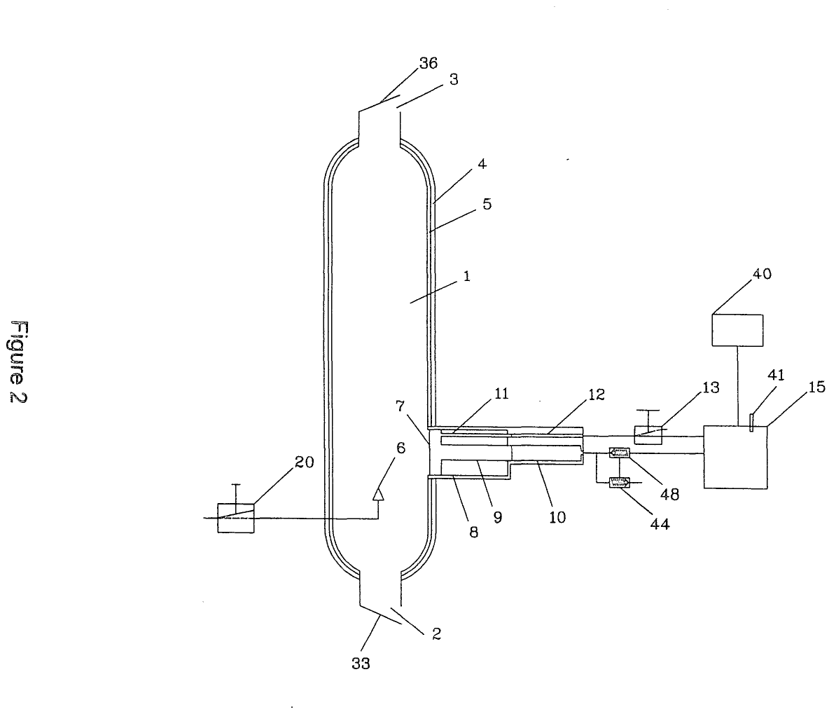

FIG. 2—illustrates an enlarged view of a pressure vessel of FIG. 1 with master piston and master cylinder and slave piston and cylinder and return piston and cylinder.

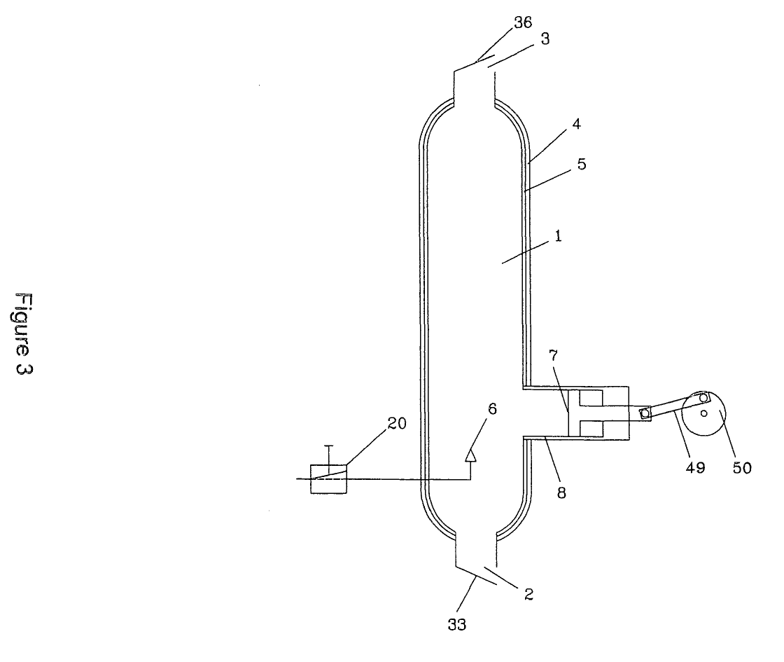

FIG. 3—illustrates a view of a pressure vessel of the present invention with the master piston and cylinder connected via a cam rod to a crankshaft.

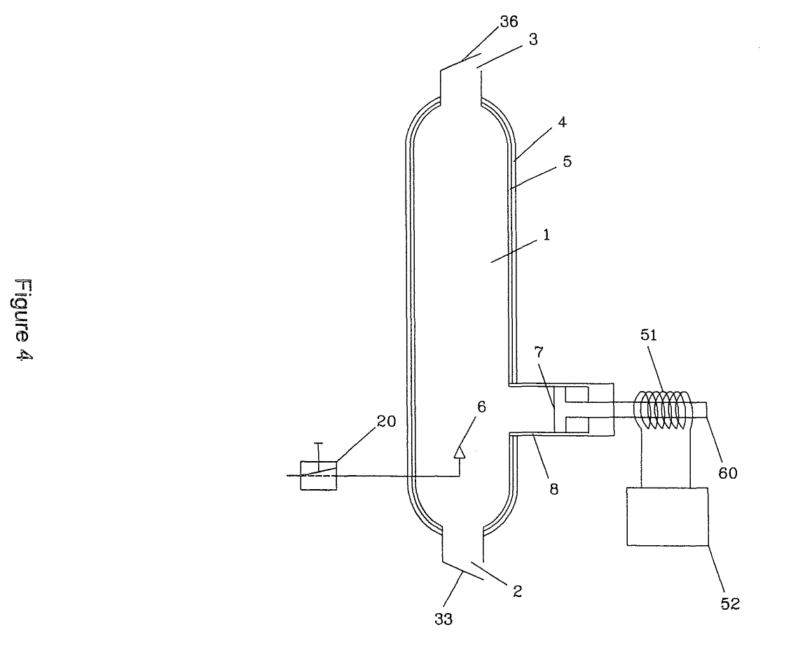

FIG. 4—illustrates an energy conversion apparatus according to the present invention in an arrangement for generating an electro-motive force.

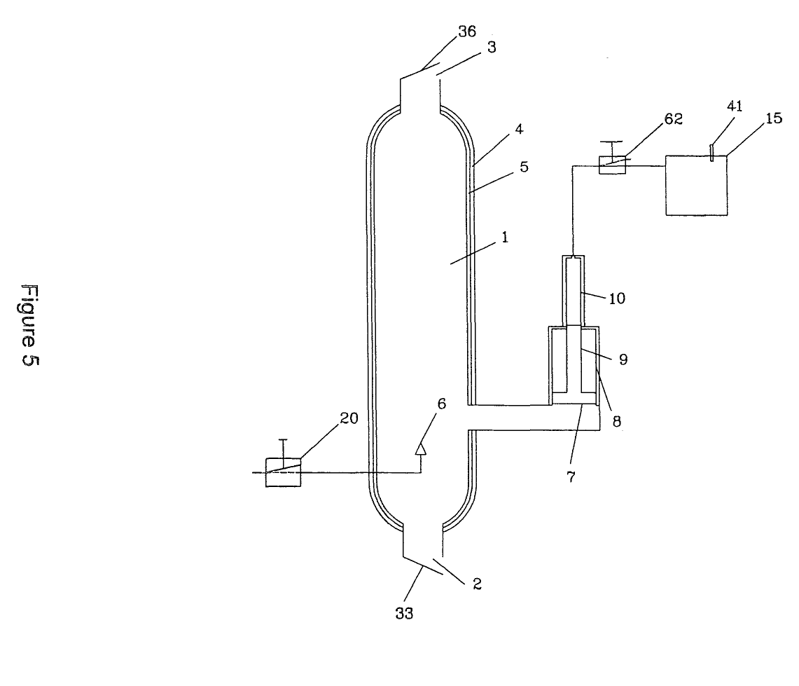

FIG. 5—illustrates an alternative arrangement of the energy conversion device of the present invention.

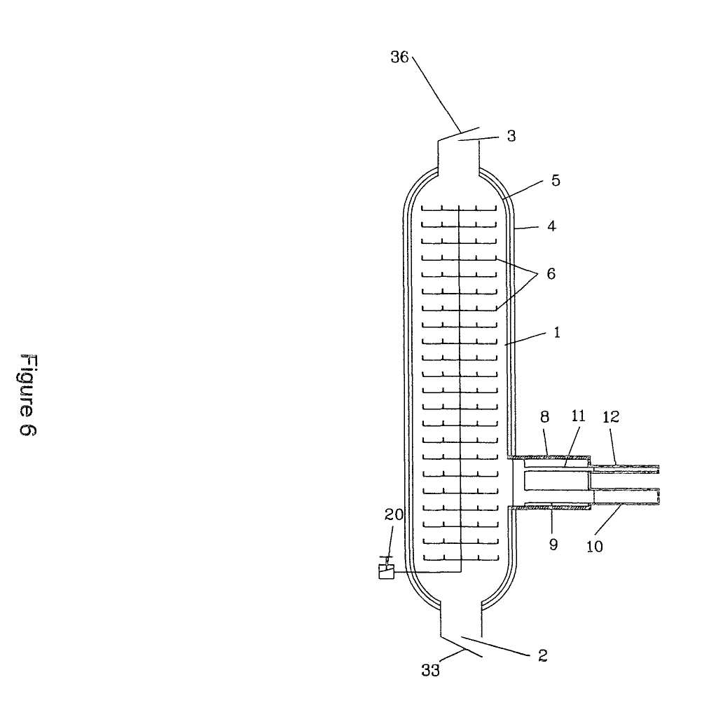

FIG. 6—illustrates a further embodiment of the present invention with a series of nozzles arranged in rows.

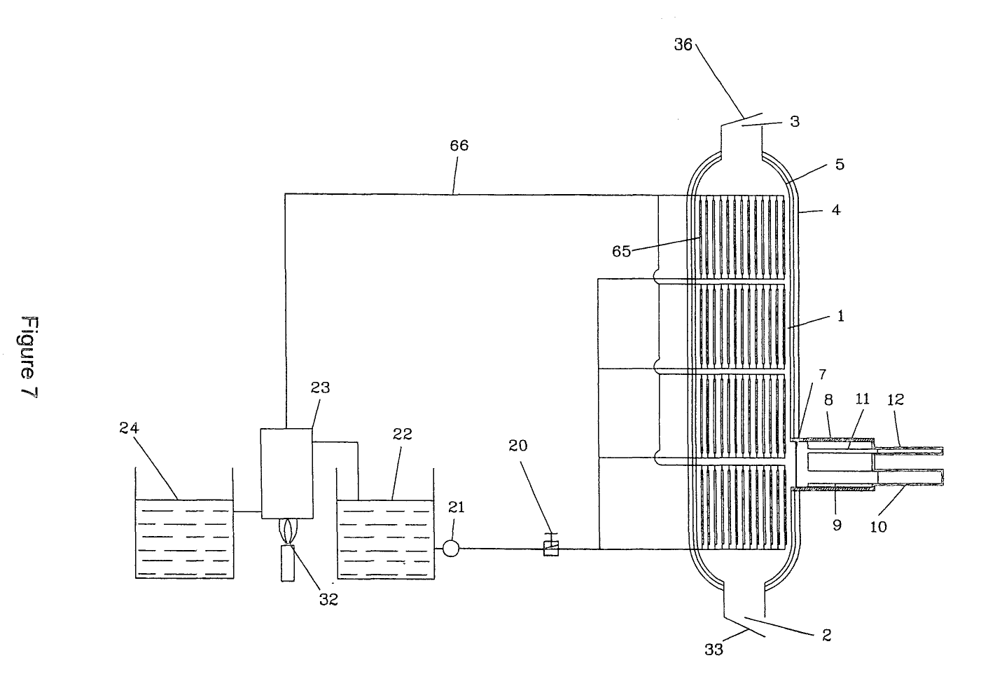

FIG. 7—illustrates a further embodiment of the present invention with a bank of heat exchangers.

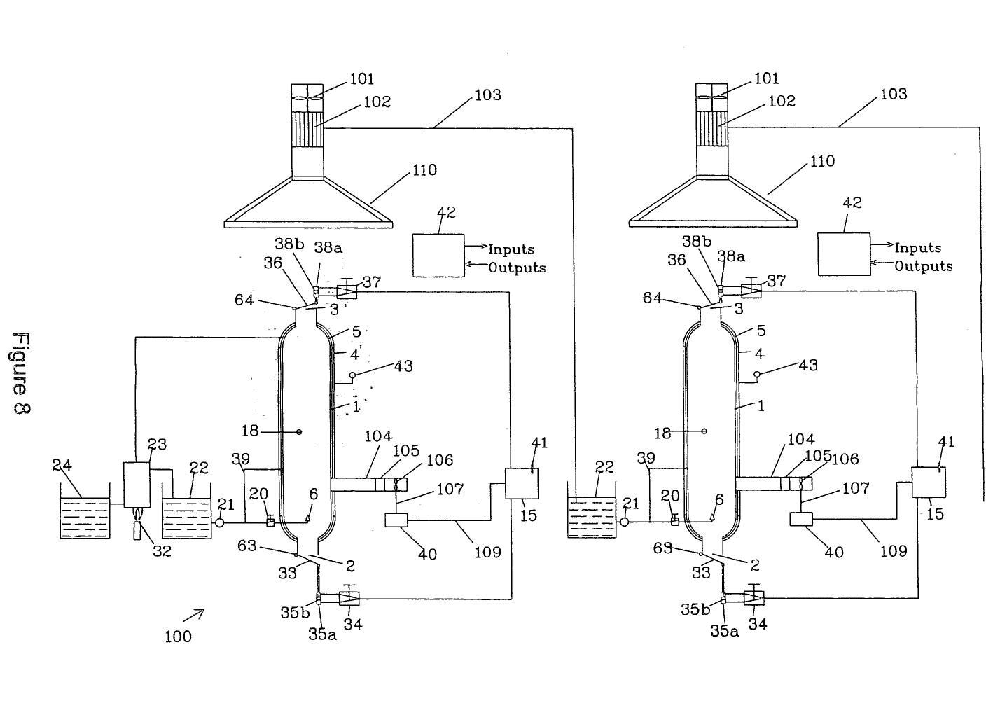

FIG. 8—illustrates a further embodiment of the present invention in which a duct is included in the device.

Referring first of all to FIGS. 1 and 2 of the accompanying drawings, there is illustrated a power conversion device 100 according to a first embodiment of the present invention. The power conversion device comprises a pressure vessel 1, wherein a volume of fluid within pressure vessel 1, is in fluid communication with a master piston 7. The master piston 7, is housed within a master cylinder 8. The pressure vessel 1 has a first inlet 2, 275 preferably at one end, for example the bottom of the pressure vessel and a second outlet 3, preferably at a second end, for example the top of the pressure vessel.

In operation, the device functions by means of a cycle in which an amount of compressed fluid such as, for example, air is supplied to a reservoir 15, by means of, for example, a compressor 40. A pressure sensor 41 is used to monitor the pressure within the reservoir 15. The said pressure sensor 41 is preferably connected to a computer control unit 42. When it is determined by the computer control unit that the pressure within the reservoir 15, is sufficient to enable the cycle to commence, a first valve 37 opens thereby allowing fluid to enter a cylinder and piston 38a and 38b respectively, which in turn release an outlet hatch 36, which in turn opens an outlet 3, of the pressure vessel 1. A second valve 34, also opens at substantially the same time as the first valve 37 opens thereby allowing fluid to enter a cylinder and piston 35a and 35b respectively, which in turn release a hatch 33, which in turn open an inlet 2, of the pressure vessel 1.

When the inlet hatch 33, and the outlet hatch 36 of the pressure vessel 1 are both open, any fluid, for example air, within the pressure vessel 1, that is of a temperature greater than the temperature of the fluid outside of the pressure vessel 1, will rise due to the effect of natural convection. As the fluid, for example, air rises and exits the pressure vessel 1 through the outlet hatch 36, it will be replaced by fluid, for example air of a lower temperature which is drawn through the inlet hatch 33 into the pressure vessel.

Once the inlet hatch 33, and the outlet hatch 36, are both open, a further valve 13, is activated to allow compressed fluid, such as for example air from the reservoir 15, to enter a return cylinder 12, thereby causing movement of a return piston 11. The return piston 11 is connected to the master piston 7. When compressed fluid such as for example air, flows into the return cylinder 12, and acts against the return piston 11, the return piston 11 then reciprocally acts on the master piston 7. When the master piston 7 is extended to its limit, any fluid (such as for example air) is expelled from the master cylinder 8 and into the pressure vessel 1. Once inside the pressure vessel 1, the air can be exhausted along with any other fluid from within the pressure vessel 1.

The power conversion device further comprises a slave piston 9, which is connected to the master piston 7. When the return piston 11, travels along the return cylinder 12, thereby acting against the master piston 7, the return piston 11 also acts against the slave piston 9, such that the slave piston 9, travels along the slave cylinder 10, and in so doing draws fluid (such as for example air) into the slave cylinder 10, through a non-return valve 44.

There is preferably at least one temperature sensor 18, located within the pressure vessel 1, and connected to the computer control unit 42. There is also preferably at least one temperature sensor 43, located outside of the pressure vessel 1, which is also preferably connected to the computer control unit 42. The computer control unit 42, determines when the temperature of the fluid (for example air) within the pressure vessel 1, is at the lowest possible temperature and only then does the computer control unit 42, activate the valve 34, thereby allowing fluid to enter cylinder and piston 35a and 35b respectively which in turn closes the hatch 33. At the same time the computer control unit 42 activates the valve 37, thereby allowing fluid (for example air) to enter the cylinder and piston 38a and 38b respectively, which in turn closes the hatch 36. The minimum temperature differential at which the computer control unit 42 will enable the conversion device to operate is preferably in the range of 10° C. for T1 and T2, wherein T1 and T2 are the temperatures of the fluids outside and inside the pressure vessel respectively. However, the efficiency of the device is increased as the temperature differential between the fluids giving rise to T1 and T2 also increases.

In order to maximise the energy conversion, the temperature value T1, external to the pressure vessel is preferably as low as possible, for example −40° C. whilst the temperature provided by the fluid on the inside of the pressure vessel T2 (such as for example a water spray) is preferably as high as possible, for example, 99° C. Consequently the maximum pressure differential is in the region of 139° C.

The device according to the present invention further comprises an inlet hatch proximity switch 63, and an outlet hatch proximity switch 64. When the inlet and outlet proximity switches 63 and 64 detect that the inlet hatch 33, and the outlet hatch 36 are closed, a water pump 21, is activated which pumps fluid, (water) of a temperature T3 from a water reservoir 22, inside a cavity wall 5, of the pressure vessel 1. Once inside the cavity wall of the pressure vessel, the water of temperature T3 circulates around the cavity wall 5, of the pressure vessel 1 before returning to the reservoir 22, via a heat exchanger 23. The fluid, (for example water) circulating within the cavity wall 5, of the pressure vessel 1, increases the temperature of the inside wall 47, of the pressure vessel 1, which in turn starts to increase the temperature of the fluid (such as for example air) within the pressure vessel 1.

In accordance with the present invention it is anticipated that the temperature of the fluid such as water in the reservoir 22 is in the range of between 10° C. to 99° C., more preferably 20° C. to 99° C. and most preferably 40° C. to 99° C.

It will be appreciated by one skilled in the art that whilst water is the preferred fluid located in the water reservoir 22 other fluids could also be employed. It will also be appreciated that whilst the master piston 7 is described as being located within the master cylinder 8, the master piston 7 could equally reside adjacent the master cylinder 8 and be co-operatively connected thereto. This same situation as highlighted above also applies to the return cylinder 12 and return piston 11 and the slave piston 9 and slave cylinder 10.

As mentioned above, at least one temperature sensor 18, within the pressure vessel 1, is connected back to the computer control unit 42. The sensor 18 enables the computer control unit 42, to determine when to activate an injection valve 20. Injection valve 20 allows fluid of temperature T4 such as for example water, to flow from the reservoir 22 to at least one injection nozzle 6 located within the pressure vessel 1 (for example, as a fine spray).

As fluid (for example water) of the second temperature T4 is sprayed out of the at least one injection nozzle 6, into the pressure vessel 1, heat from the fluid (water) is transferred to the fluid (such as air) of a first temperature T3. The volume of the fluid (air) of the first temperature T3 therefore expands as the temperature rises within the pressure vessel 1. The expansion of the fluid (air) within pressure vessel 1, thereby forces the master piston 7, to travel along the master cylinder 8. The master piston 7 is connected to the slave piston 9. Consequently, movement of the master piston 7, causes movement of the slave piston 9. The induced movement of the slave piston 9 compresses the fluid (air) within the slave cylinder 10, and forces the said fluid through a second non-return valve 48, and into the reservoir 15.

There are preferably multiple injector nozzles 6 located within the pressure vessel 1. The exact number of injection nozzles will depend upon the size of the pressure vessel, which will in turn depend upon the amount of heat available.

As also discussed above, the pressure vessel 1 has located within it a pressure sensor 18, which is connected to the computer control unit 42. The computer control unit 42 uses the information from the pressure sensor 18 and determines when the master piston 7, has traveled to its maximum extent. When this is achieved, the cycle commences once again.

When the hatches 33 and 36 are closed, the pressure within all parts of the pressure vessel 1 is substantially constant such that only one pressure sensor is required to detect changes in the vessel. However, it will be appreciated by one skilled in the art that more than one sensor may be employed to improve the accuracy of the readings taken, or to act as a ‘back-up’ system in the event of the sensor 18 failing to operate.

The water pump 21 continues to pump for as long as the power conversion device is active and may not stop at the end of each cycle. The compressed fluid stored within the reservoir 15, may be used for example to drive a turbine or a pump (not shown) to for example generate electricity. Alternatively, once the reservoir is full, the excess air may be diverted for example to a turbine or pump to generate for example electricity. The reservoir may therefore also include a sensor to monitor its capacity as appropriate.

FIG. 3 of the accompanying drawings illustrates an alternative arrangement of the present invention. In FIG. 3 the power conversion device again employs the temperature differential of fluids as the source of energy to effect movement of a master piston 7, within a master cylinder 8. However, in FIG. 3, the master piston 7 is connected to a cam rod 49, which is in turn connected to a crankshaft 50. When fluid within the pressure vessel 1 expands thereby forcing the master piston 7 to move along the length of the master cylinder 8, the said connecting cam rod 49, forces the crankshaft 50 to rotate.

It will again be appreciated by one skilled in the art that a series of pressure vessels, master pistons and master cylinders and cam rods may be provided in series along a crankshaft in order to increase the output of the device.

In FIG. 4 there is illustrated a further embodiment of the present invention in which the power conversion device again employs the temperature differential of fluids as the source of energy to effect movement of a master piston 7, within a master cylinder 8. In FIG. 4 however, the master piston 7 is connected to an electromagnetic inductive bar 60, the said electromagnetic inductive bar being housed within an inductive coil 51. When fluid within the pressure vessel 1 expands thereby forcing master piston 7 to move along the length of the master cylinder 8, the electromagnetic inductive bar connected to the master piston 7, is forced through the inductive coil 51, thereby inducing an electro-motive force. The electro-motive force may then feed into for example control circuitry 52. For instance, a portion of the energy generated by the electro-motive force may preferably be stored within control circuitry 52 such that, when the inlet and outlet hatches 33 and 36 are open, and any pressure within the vessel 1 is prevented from acting upon the piston 7 and stored energy within the control circuitry 52 may be fed into the inductive coil 51. Consequently, as current flows through the inductive coil 51, the inductive bar 60 and hence piston 7, is forced along the cylinder 8 in readiness for the next cycle.

In FIG. 5 of the accompanying drawings there is illustrated a further embodiment of the present invention. Once again the power conversion device in FIG. 5 employs the temperature differential of fluids as the source of energy to effect movement of a master piston 7, within a master cylinder 8. In the arrangement shown in FIG. 5 however, the master piston 7 is mounted on a vertical axis. When fluid within pressure vessel 1, expands thereby forcing the master piston 7, to move in an upward direction through the master cylinder 8, the slave piston 9, compresses the fluid within the slave cylinder 10, and the computer control unit 42 (not shown) opens a two way valve 62, thereby diverting the compressed fluid from the slave cylinder 10, into the reservoir 15.

When the master piston 7, has reached the limit of its stroke, the inlet 2, and the outlet 3, of the pressure vessel 1 open, and the two way valve 62 closes the connection from the slave cylinder 10 to the reservoir 15, and the two way valve 62, opens the connection between the slave cylinder 10 and the atmosphere. The master piston 7, then falls due to the effect of gravity and as it falls the slave piston 9 draws into the slave cylinder 10, fluid such as for example air from the atmosphere. In this alternative embodiment it will be appreciated there is no need for a compressor to be connected to the reservoir 15.

In FIG. 6 there is illustrated a pressure vessel 1 in which multiple nozzles 6 are arranged in rows extending from the bottom to the top of the pressure vessel. The remaining components of the device remain the same

In FIG. 7 there is illustrate a pressure vessel 1 in which the multiple rows of nozzles as shown in FIG. 6 have been replaced by a bank of heat exchangers 65. The remaining components of the device again remain the same. For the device in FIG. 7, instead of spraying a fluid such as water through the nozzles into the pressure vessel, the fluid moves through the device via the heat exchanges 65. The heat exchangers offer a very large surface area.

One of the main advantages of using a bank of heat exchangers in place of one or more nozzles for spraying fluid into the pressure vessel is that when there is a shortage or serious lack of available water as a source of fluid, the device in FIG. 7 provides a closed system such that no valuable water is lost to the environment as vapour when the inlet and outlet hatches 33 and 36 of the pressure vessel are opened. Furthermore, the device illustrated in FIG. 7 with the bank of heat exchangers 65 is able to operate using a lower temperature differential between the two fluid forms denoted by T3 and T4 (such as air and water) in the device.

In operation, valve 20a in the device in FIG. 7 closes and prevents fluid from travelling through the heat exchangers when the inlet and outlet hatches 33 and 36 at the top and bottom of the pressure vessel are open.

Once warmed fluid (air) from within the pressure vessel has escaped via the top hatch 36 and been subsequently replaced by cooler air entering the pressure vessel via bottom hatch 33, and the hatches closed, valve 20a is opened and allows fluid to travel through the bank of heat exchangers 65.

The large surface area of the heat exchangers ensures that it is possible for the heat from the fluid within the heat exchangers to be transmitted to fluid (for example air) outside of the heat exchangers. In operation, as the temperature of the fluid (air) outside the heat exchangers expands, it forces the piston 7 to travel along the cylinder 8 and hence operate in the same manner as the device illustrated in FIG. 1. Fluid (water) within the heat exchangers is circulated by means of connecting conduit 66 into the reservoir 22.

In FIG. 8 there is illustrated a further embodiment of the present invention in which a duct 104 may be attached to the system to capture exhausted air, in order to recover any lost heat from the exhaust. FIG. 8 also shows how a turbine may be used to generate electricity from the pressure created within the pressure vessel.

In the embodiment illustrated in FIG. 8, fluid is injected into the pressure vessel 1, through an injector 6. As the volume of air in the pressure vessel 1 expands creating a pressure, one or more sensors (not shown) located within the pressure vessel 1 detect the increase in pressure and the computer control unit (cpu) 42 sends a signal to the valve 105, thereby opening valve 105 and allowing the pressurised air to travel into the turbine 106. This causes turbine 106 to turn thereby generating electricity.

A portion of the electrical power generated by the turbine 106 may be used to power a compressor 40. The turbine 106 is connected to the reservoir 41 by a connecting mechanism 107. The compressed air is supplied to the reservoir 41 by a connecting means or conduit 109. The compressed air may be used to supply power to operate the various valves and pistons associated with the apparatus.

A large proportion of the power generated in the turbine 106 of the system may be diverted for use by external equipment.

A canopy 110 is shown in FIG. 8, for collecting the exhausted air (or fluid) from the pressure vessel 1 once the expanded air has been used to drive the turbine 106.

Attached to the canopy 110 is a heat exchanger 102. This heat exchanger 102 may be used to extract heat from the exhausted air and supply a reservoir of fluid for use in a second cycle by a further set of apparatus. In FIG. 8, two sets of apparatus are effectively joined by way of the canopy 110 and reservoir 22. The further second set of apparatus located on the right of the Figure is the same as the first set but the purpose of the second set is to extract a further amount of energy in a repeat of the previous process. A further turbine 101 is also connected to the canopy.

This process of ‘energy extraction’ may be repeated a number of times to extract as much energy from the waste heat as possible.

Whilst the embodiments above describe the use of heat from for example warmed water, other warmed liquids may be employed and other gases may be utilised in place instead of air. It will be appreciated that it is intended that the scope of the present invention is to cover the use of fluids of different temperatures in an energy conversion device.

In addition the modifications and alternative power sources described above may be applied to each of the examples of apparatus illustrated.

It is also envisaged that the present invention may be used on a small scale to power appliances requiring only a low energy input, for example, the apparatus may be used to power appliances such as but not limited to garden lights. For such an application, the air may be compressed manually, for example using a hand pump, and warmed water may be supplied from for example a bucket of water that has been heated by solar means. However, it will also be appreciated that the above device may be used on a much larger scale for providing amounts of energy. For example, many industrial processes generate and hence waste heated water, water that has often been heated to a very high temperature and which then has to be disposed of. The present invention therefore provides use for such wastewater in the production of motive power therefrom.

The present invention will now be further demonstrated by means of the following example of a cycle of the device as follows.

### EXAMPLE 1

An operation of a cycle of the device occurs as follows:

### Sequence of Operations.

1. Valve 20 opens and warm water is pumped through the walls of the pressure vessel.
2. Valves 34 and 37 open and the inlet and outlet shutters open together.
3. Compressed air from the reservoir 15 is fed via valve 13 to the return piston, which pushes the master piston to its fullest extent. (When the master piston is at its fullest extent the volume of the air within the pressure vessel is at a minimum).
4. As the master piston moves, due to its connection to the slave piston, air is drawn into the slave cylinder through a non-return valve.
5. The warm air in the pressure vessel rises and leaves the pressure vessel through the outlet at the top of the pressure vessel.
6. As the warm air leaves the pressure vessel, it creates a vacuum with the result that cold air is drawn through the inlet at the bottom of the pressure vessel.
7. With the aid of sensors 18, 43 inside and outside of the pressure vessel, which are connected back to the central processing unit, it is possible to determine when the air temperature inside of the pressure vessel is as low as possible.
8. Valves 34 and 37 then actuate to supply air to cylinders 35 and 38 to close the inlet and outlet hatches.
9. Also at this point the master piston has reached its fullest extent. This reduces the volume of the pressure vessel to a minimum.
10. Warm water flowing through the walls of the pressure vessel warms the walls of the vessel and also now begins to warm up the air inside of the pressure vessel.
11. Valve 20 is then opened which allows water to be injected into the pressure vessel through the spay nozzles.
12. The large surface area of the warm water spray warms up the air inside of the pressure vessel.
13. As the air inside the pressure vessel warms up, it expands and pushes against the master piston.
14. As the master piston moves along the master cylinder, due to its connection to the slave piston, the slave piston moves along the slave cylinder compressing the air within the slave cylinder. The compressed air is then fed into the reservoir via non-return valve 48.
15. Pressure sensors within the pressure vessel and proximity switches fitted to the master piston determine with the central processing unit when the master piston has traveled to its fullest extent.
16. At this point the cycle starts again.

1. A power conversion device suitable for converting a temperature differential between two fluids into a source of energy comprising: a pressure vessel comprising at least one inlet hatch, suitable for receiving a first fluid of a first temperature and at least one outlet hatch suitable for venting said first fluid; and a fluid dispersal means for dispersing a second fluid of a second temperature greater than the temperature of the first fluid; and further comprising at least one master piston moveable with respect to at least one master cylinder between a first and second position, said master piston and master cylinder in fluid communication with the pressure vessel such that the fluid dispersal means causes the second fluid to increase the temperature and volume of the first fluid resulting in movement of the master piston within the master cylinder.

2. A power conversion device according to claim 1 further comprising an automatic control means to effect opening and closing of the inlet and outlet hatches and/or activation of the fluid dispersal means.

3-5. (canceled)

6. A power conversion device according to claim 1 further comprising a return cylinder and a return piston in fluid communication with the master cylinder and master piston.

7. (canceled)

8. A power conversion device according to claim 1 further comprising a slave piston and slave cylinder in fluid communication with the master cylinder and master piston.

9-12. (canceled)

13. A power conversion device according to claim 1 wherein at least one sensor is provided on the inside of the pressure vessel and at least one sensor is provided external to the pressure vessel, and wherein said sensors are connected to the central processing unit.

14. A power conversion device according to claim 13 wherein there is a temperature differential of at least 10° C. between any temperature readings recorded by the sensors on the inside and outside of the pressure vessel respectively.

15. A power conversion device according to claim 13 wherein a maximum temperature differential of 139° C. exists between any temperature readings recorded by the sensors on the inside and outside of the pressure vessel respectively.

16-19. (canceled)

20. A power conversion device according to claim 1 wherein the pressure vessel comprises a cavity wall for receiving the second fluid.

21. (canceled)

22. A power conversion device according to claim 1 wherein the temperature of the second fluid is in the range of 10° C. to 99° C.

23-28. (canceled)

29. A power conversion device according to claim 1 wherein the fluid dispersal means comprises at least one heat exchanger.

30-38. (canceled)

39. A power conversion device according to claim 1 wherein the pressure vessel is connected by means of a duct to a turbine for generating electricity.

40. A power conversion device according to claim 1 wherein the device further comprises a canopy for collecting exhausted air of fluid form the pressure vessel.

41. (canceled)

42. A power conversion device according to claim 1 wherein the device comprises two or more pressure vessels connected in series.

43. A method suitable for transferring a temperature differential of at least two fluids into motive power comprising the steps of: moving at least one master piston within at least one master cylinder; introducing a first fluid of a first temperature into a pressure vessel, said pressure vessel in fluid communication with the at least one master piston; introducing a second fluid of a second temperature into said pressure vessel so as to cause expansion of the first fluid in the pressure vessel and thereby cause movement of the at least one master piston within the master cylinder in a first direction.

44. (canceled)

45. A method according to claim 43 wherein movement of the master piston with the master cylinder causes movement of a slave piston within a slave cylinder that compresses the first fluid through a non-return valve into a first reservoir.

46-51. (canceled)

52. A method according to claim 43 wherein the method further comprises the step of moving a return piston within a return cylinder to move the at least one master piston within the master cylinder in a second direction, and wherein movement of the master cylinder in the second direction coincides with opening of at least one inlet hatch, and at least one outlet hatch.

53. A method according to claim 52 wherein the method further comprises the steps of closing the at least one inlet hatch, and at least one outlet hatch when fluid in the pressure vessel is of a pre-determined temperature.

54. (canceled)

55. A method according to claim 52 further comprising the steps of introducing the second fluid of a second temperature into the pressure vessel when the inlet and outlet hatches are closed.

56-57. (canceled)

58. A method according to claim 43 wherein introduction of the second fluid of a second temperature into the pressure vessel causes expansion of the first fluid of the first temperature to act on the master piston within the master cylinder followed by action of the master piston on a slave piston in a slave cylinder which in turn compresses the first fluid of the first temperature which is forced into the first reservoir via a non-return valve.

59. A method suitable for transferring a temperature differential of at least two fluids into motive power comprising the steps of: introducing a first fluid of a first temperature into a pressure vessel, said pressure vessel in fluid communication with at least one master piston; introducing a second fluid of a second temperature into said pressure vessel so as to cause expansion of the first fluid in the pressure vessel and thereby cause movement of the first fluid along a duct to a turbine and thereby induce movement in the turbine.

60-61. (canceled)
